(19) United States
(12) Patent Application Publication
(10) Pub. No.: US 2008/0230251 A1
(43) Pub. Date: Sep. 25, 2008

(54) CROSSLINKED AUTOMOTIVE WIRE HAVING IMPROVED SURFACE SMOOTHNESS

(75) Inventors: Thomas S. Lin, Whippany, NJ (US); Kurt A. Bolz, Allentown, NJ (US); Jeffrey M. Cogen, Flemington, NJ (US); Neil W. Dunchus, Kinnelon, NJ (US); Benjamin R. Rozenblat, Belle Mead, NJ (US)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 12/060,635

(22) Filed: Apr. 1, 2008

Related U.S. Application Data
(63) Continuation-in-part of application No. 11/659,579, filed on Sep. 19, 2007.

(51) Int. Cl. H01B 7/18

(52) U.S. Cl. 174/102 R

(57) ABSTRACT

The present invention is a crosslinked automotive wire comprising a metal conductor, a flame retardant insulation layer surrounding the metal conductor, and optionally, a wire jacket surrounding the insulation layer. The automotive wire passes the specifications of one or more several automotive cable testing protocols: (a) SAE J-1128, (b) ISO-6722, (c) LV 112, (d) Chrysler MS-8288, and (e) Renault 36-36-05-009/-L. In particular, the flame retardant insulation layer is prepared from a crosslinkable thermoplastic polymer and a metal carbonate. The flame retardant composition for making the insulation layer demonstrates economic and processing improvements over conventional solutions. The present invention is also a method for preparing a low tension primary automotive wire and the automotive wire made therefrom.

### CROSS-REFERENCE TO RELATED APPLICATIONS

This Application is a Continuation-in-part of application Ser. No. 11/659,579 filed on Feb. 7, 2007.

### BACKGROUND OF THE INVENTION

This invention relates to automotive wire-and-cable applications. In particular, the present invention relates to insulation materials for low-tension primary wire applications.

Generally, automotive wires are required to achieve certain flame retardant performance as set forth by the Society of Automotive Engineers (SAE), industry organizations, or various automobile manufacturers. For example, low tension primary cables must comply with one or more of the specifications of SAE J-1128, ISO-6722, LV 112, Chrysler MS-8288, and Renault 36-36-05-009/-L.

Notably, polyolefin-based formulations, incorporating a metal hydroxide or combinations of metal hydroxides as flame retardants, were designed to fulfill the various specifications. Unfortunately, these solutions have proved inadequate because high amounts of metal hydroxides are required to impart flame retardancy, thereby adding significant cost to formulations.

Within the class of metal hydroxides, certain metal hydroxides raise processing problems. For example, aluminum trihydroxide (ATH) raises compounding rate problems. Specifically, ATH decomposes at temperatures above about 175 degrees Celsius. Also, polyolefin-based formulations with halogenated flame retardants pose their own set of problems. Notably, they pose environmental concerns and are expensive solutions.

Accordingly, there is a need for a low-cost alternative to formulations containing high amounts of metal hydroxides or halogenated flame retardants which achieves SAE J-1128 performance and other specifications. More specifically, there is a need for a low-cost, processable alternative which utilized the flame retardant advantages of the metal hydroxides and minimizes the amount of metal hydroxide required to manifest those advantages. There is also a need for a method for selecting such compositions.

### BRIEF SUMMARY OF THE INVENTION

The present invention is a crosslinked automotive wire comprising a metal conductor, a flame retardant insulation layer surrounding the metal conductor, and optionally, a wire jacket surrounding the insulation layer. The automotive wire passes the specifications of one or more several automotive cable testing protocols: (a) SAE J-1128, (b) ISO-6722, (c) LV 112, (d) Chrysler MS-8288, and (e) Renault 36-36-05-009/-L. In particular, the flame retardant insulation layer is prepared from a crosslinkable thermoplastic polymer and a metal carbonate, wherein the polymer is an ethylene/unsaturated ester copolymer having a minimum ester content, the metal carbonate has a particle size less than about 3 microns, or both. The flame retardant composition for making the insulation layer demonstrates economic and processing improvements over conventional solutions as well as improved surface smoothness. The present invention is also a method for preparing a low tension primary automotive wire and the automotive wire made therefrom.

### DETAILED DESCRIPTION OF THE INVENTION

The invented crosslinked automotive wire comprises a metal conductor, a flame retardant insulation layer surrounding the metal conductor, and optionally, a wire jacket surrounding the insulation layer. The automotive wire passes the specifications of one or more several automotive cable testing protocols: (a) SAE J-1128, (b) ISO-6722, (c) LV 112, (d) Chrysler MS-8288, and (e) Renault 36-36-05-009/-L.

The metal conductor may be any of the well-known metallic conductors used in automotive wire applications, such as copper.

The flame retardant insulation layer is prepared from a flame retardant composition comprising a crosslinkable thermoplastic polymer and a metal carbonate. The metal carbonate is present in an amount sufficient to impart a time to peak heat release (TTPHRR), measured using cone calorimetry with a heat flux of 35 kW/m², of greater than or equal to about 140 seconds to a test specimen, having a length and width of 100 mm and a thickness of 1.3 mm. More preferably, the TTPHRR is greater than or equal to 145 seconds. Preferably, the flame retardant composition contains less than about 2 weight percent of a silicone polymer. More preferably, the flame retardant composition is substantially free of a silicone polymer.

The crosslinkable thermoplastic resin is preferably a polyolefin. Suitable polyolefins include ethylene polymers, propylene polymers, and blends thereof. Preferably, the polyolefin polymers are substantially halogen-free.

Ethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1-butene, 1-hexene, 4-methyl-1-pentene, and 1-octene. The polyethylene can also be a copolymer of ethylene and an unsaturated ester such as a vinyl ester (for example, vinyl acetate or an acrylic or methacrylic acid ester), a copolymer of ethylene and an unsaturated acid such as acrylic acid, or a copolymer of ethylene and a vinyl silane (for example, vinyltrimethoxysilane and vinyltriethoxysilane).

The polyethylene can be homogeneous or heterogeneous. The homogeneous polyethylenes usually have a polydispersity (Mw/Mn) in the range of 1.5 to 3.5 and an essentially uniform comonomer distribution, and are characterized by a single and relatively low melting point as measured by a differential scanning calorimeter. The heterogeneous polyethylenes usually have a polydispersity (Mw/Mn) greater than 3.5 and lack a uniform comonomer distribution. Mw is defined as weight average molecular weight, and Mn is defined as number average molecular weight.

The polyethylenes can have a density in the range of 0.860 to 0.960 gram per cubic centimeter, and preferably have a density in the range of 0.870 to 0.955 gram per cubic centimeter. They also can have a melt index in the range of 0.1 to 50 grams per 10 minutes. If the polyethylene is a homopolymer, its melt index is preferably in the range of 0.75 to 3 grams per 10 minutes. Melt index is determined under ASTM D-1238, Condition E and measured at 190 degree C. and 2160 grams.

Low- or high-pressure processes can produce the polyethylenes. They can be produced in gas phase processes or in liquid phase processes (that is, solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these polyethylenes include magnesium/titanium-based catalyst systems, vanadium-based catalyst systems, chromium-based catalyst systems, metallocene catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene copolymers.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degree C. In the stirred autoclave, the pressure is in the range of 10,000 to 30,000 psi and the temperature is in the range of 175 to 250 degree C.

The most preferred polymers are copolymers comprised of ethylene and unsaturated esters or acids, which are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of 5 to 50 percent by weight based on the weight of the copolymer. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. Examples of the unsaturated acids include acrylic acids or maleic acids.

The melt index of the ethylene/unsaturated ester copolymers or ethylene/unsaturated acid copolymers can be in the range of about 0.5 to about 50 grams per 10 minutes, and is preferably in the range of about 2 to about 25 grams per 10 minutes.

In particular, the most preferred ethylene/unsaturated ester copolymer should have an unsaturated ester content of greater than or equal to about 10 weight percent to achieve good surface smoothness. Even more preferably, the unsaturated ester should be vinyl acetate or ethyl acrylate.

Copolymers of ethylene and vinyl silanes may also be used. Examples of suitable silanes are vinyltrimethoxysilane and vinyltriethoxysilane. Such polymers are typically made using a high-pressure process. Use of such ethylene vinylsilane copolymers is desirable when a moisture crosslinkable composition is desired. Optionally, a moisture crosslinkable composition can be obtained by using a polyethylene grafted with a vinylsilane in the presence of a free radical initiator. When a silane-containing polyethylene is used, it may also be desirable to include a crosslinking catalyst in the formulation (such as dibutyltindilaurate or dodecylbenzenesulfonic acid) or another Lewis or Bronsted acid or base catalyst.

The VLDPE or ULDPE can be a copolymer of ethylene and one or more alpha-olefins having 3 to 12 carbon atoms and preferably 3 to 8 carbon atoms. The density of the VLDPE or ULDPE can be in the range of 0.870 to 0.915 gram per cubic centimeter. The melt index of the VLDPE or ULDPE can be in the range of 0.1 to 20 grams per 10 minutes and is preferably in the range of 0.3 to 5 grams per 10 minutes. The portion of the VLDPE or ULDPE attributed to the comonomer(s), other than ethylene, can be in the range of 1 to 49 percent by weight based on the weight of the copolymer and is preferably in the range of 15 to 40 percent by weight.

A third comonomer can be included, for example, another alpha-olefin or a diene such as ethylidene norbornene, butadiene, 1,4-hexadiene, or a dicyclopentadiene. Ethylene/propylene copolymers are generally referred to as EPRs and ethylene/propylene/diene terpolymers are generally referred to as an EPDM. The third comonomer can be present in an amount of 1 to 15 percent by weight based on the weight of the copolymer and is preferably present in an amount of 1 to 10 percent by weight. It is preferred that the copolymer contains two or three comonomers inclusive of ethylene.

The LLDPE can include VLDPE, ULDPE, and MDPE, which are also linear, but, generally, has a density in the range of 0.916 to 0.925 gram per cubic centimeter. It can be a copolymer of ethylene and one or more alpha-olefins having 3 to 12 carbon atoms, and preferably 3 to 8 carbon atoms. The melt index can be in the range of 1 to 20 grams per 10 minutes, and is preferably in the range of 3 to 8 grams per 10 minutes.

Any polypropylene may be used in these compositions. Examples include homopolymers of propylene, copolymers of propylene and other olefins, and terpolymers of propylene, ethylene, and dienes (for example, norbornadiene and decadiene). Additionally, the polypropylenes may be dispersed or blended with other polymers such as EPR or EPDM. Examples of polypropylenes are described in POLYPROPYLENE HANDBOOK: POLYMERIZATION, CHARACTERIZATION, PROPERTIES, PROCESSING, APPLICATIONS 3-14, 113-176 (E. Moore, Jr. ed., 1996).

Suitable polypropylenes may be components of TPEs, TPOs and TPVs. Those polypropylene-containing TPEs, TPOs, and TPVs can be used in this application.

Examples of suitable metal carbonates include calcium carbonate, calcium magnesium carbonate, and magnesium carbonate. Naturally-occurring metal carbonates are also useful in the present invention, including huntite, magnesite, and dolomite. Preferably, the metal carbonate is present in an amount greater than or equal to about 10 weight percent. More preferably, the metal carbonate is present in an amount greater than or equal to about 20 weight percent.

The flame retardant composition may also comprise metal hydrates. Suitable examples include aluminum trihydroxide (also known as ATH or aluminum trihydrate) and magnesium hydroxide (also known as magnesium dihydroxide). Other flame-retarding metal hydroxides are known to persons of ordinary skill in the art. The use of those metal hydroxides is considered within the scope of the present invention. The metal hydroxide may be naturally occurring or synthetic.

The surface of the metal carbonates and the metal hydroxide may be coated with one or more materials, including silanes, titanates, zirconates, carboxylic acids, and maleic anhydride-grafted polymers. Suitable coatings include those disclosed in U.S. Pat. No. 6,500,882.

The average particle size of the metal carbonate and when present, the metal hydroxide, may range from less than 0.1 micrometers to 50 micrometers. In some cases, it may be desirable to use a metal carbonate or a metal hydroxide having a nano-scale particle size.

To achieve the desired level of surface smoothness, the metal carbonate, the metal hydroxide, or both should have a particle size less than about 3 microns. More preferably, the particle should be less than about 2.0 microns. Even more preferably, the particle should be the range of about 0.7 to about 2.0 microns.

When present, the metal hydroxide is present in an amount such that the combination of the metal carbonate and the metal hydrate impart the TTPHRR of greater than or equal to about 140 seconds to the test specimen. Preferably, the metal hydrate is present amount such that the ratio of metal carbonate to metal hydrate is at least about 1:4. Also, preferably, the metal hydrate is present in an amount less than about 40 weight percent, more preferably less than about 35 weight percent.

The flame retardant composition may contain other flame-retardant additives. Suitable non-halogenated flame retardant additives include red phosphorus, silica, alumina, titanium oxides, carbon nanotubes, talc, clay, organo-modified clay, silicone polymer, zinc borate, antimony trioxide, wollastonite, mica, hindered amine stabilizers, ammonium octamolybdate, melamine octamolybdate, frits, hollow glass microspheres, intumescent compounds, and expandable graphite. Suitable halogenated additives include decabromodiphenyl oxide, decabromodiphenyl ethane, ethylene-bis(tetrabromophthalimide), and dechlorane plus.

In addition, the flame retardant composition may contain a nanoclay. Preferably, the nano-clay having at least one dimension in the 0.9 to 200 nanometer-size range, more preferably at least one dimension in the 0.9 to 150 nanometers, even more preferably 0.9 to 100 nanometers, and most preferably 0.9 to 30 nanometers.

Preferably, the nanoclays are layered, including nanoclays such as montmorillonite, magadiite, fluorinated synthetic mica, saponite, fluorhectorite, laponite, sepiolite, attapulgite, hectorite, beidellite, vermiculite, kaolinite, nontronite, volkonskoite, stevensite, pyrosite, sauconite, and kenyaite. The layered nanoclays may be naturally occurring or synthetic.

Some of the cations (for example, sodium ions) of the nanoclay can be exchanged with an organic cation, by treating the nanoclay with an organic cation-containing compound. Alternatively, the cation can include or be replaced with a hydrogen ion (proton). Preferred exchange cations are imidazolium, phosphonium, ammonium, alkyl ammonium, and polyalkyl ammonium. An example of a suitable ammonium compound is dimethyl, di(hydrogenated tallow) ammonium. Preferably, the cationic coating will be present in 15 to 50% by weight, based on the total weight of layered nanoclay plus cationic coating. In the most preferred nanoclay, the cationic coating will be present at greater than 30% by weight, based on the total weight of layered nanoclay plus cationic coating. Another preferred ammonium coating is octadecyl ammonium.

The composition may contain a coupling agent to improve the compatibility between the crosslinkable thermoplastic polymer and the nanoclay. Examples of coupling agents include silanes, titanates, zirconates, and various polymers grafted with maleic anhydride. Other coupling technology would be readily apparent to persons of ordinary skill in the art and is considered within the scope of this invention.

In addition, the flame retardant composition may contain other additives such as antioxidants, stabilizers, blowing agents, carbon black, pigments, processing aids, peroxides, cure boosters, scorch inhibitors, and surface active agents to treat fillers may be present.

If the wire includes an optional wire jacket, the wire jacket is made of a flexible polymer material and is preferably formed by melt extrusion.

In an alternate embodiment, the flame retardant insulation layer is prepared from a flame retardant composition comprising a crosslinkable thermoplastic polymer, a metal carbonate, and a metal hydrate, wherein the combination of the metal carbonate and the metal hydrate impart a TTPHRR of greater than or equal to about 120 seconds to the test specimen. The ratio of metal carbonate to metal hydrate is at least about 1:4. Also, preferably, the metal hydrate is present in an amount less than about 40 weight percent, more preferably less than about 35 weight percent. Preferably, the flame retardant composition contains less than about 2 weight percent of a silicone polymer. More preferably, the flame retardant composition is substantially free of a silicone polymer.

In an alternate embodiment, the present invention is a method for preparing a crosslinked, low tension primary automotive wire. The steps of the invented method comprise (a) selecting a flame retardant composition for an insulating layer, (b) applying the selected flame retardant composition as an insulating layer over a metal conductor to form an insulated conductor, and (c) crosslinking the insulating layer. Optionally, this embodiment may further include the step of applying a wire jacket over the insulated conductor. Suitable crosslinking methods include peroxide, e-beam, moisture cure, and other well known methods.

In a preferred embodiment, the present invention is a low tension primary automotive wire prepared from the previously-described method. Additionally, it is believed that the flame retardant composition of the present invention is useful in appliance applications.

### EXAMPLES

The following non-limiting examples illustrate the invention.

For the exemplified compositions (Examples 1-5 and 7-12 and Comparative Example 8), the insulating compositions were compounded using a laboratory-scale Brabender mixer and analyzed using limiting oxygen index (LOI) and cone calorimetry. The LOI was conducted according to ASTM D-2863 on a 127 mm×6.4 mm×3.2 mm test specimen. The cone calorimetry was conducted according to ASTM E-1354 on a 100 mm×100 mm×1.3 mm test specimen with a heat flux of 35 kW/m2 without grids. The cone calorimetry measurements include peak heat release rate (PHRR) in kW/m², time to peak heat release rate (TTPHRR) in seconds, time to ignition (TTI) in seconds, fire growth rate index (FIGRA) in kW/m²s, and fire performance index (FPI) in s-m²/kW. The FIGRA is calculated by dividing the PHRR by the TTPHRR. The FPI is calculated by dividing the TTI by the PHRR.

The following materials were used for the exemplified compositions. The ethylene-ethyl acrylate (EEA) had a melt index of 1.30 g/10 minutes, a density of 0.93 g/cc, and an ethyl acrylate comonomer content of 15 weight percent. The EEA was obtained from The Dow Chemical Company. It is commercially available as Amplify™ EA 100. The ethylene-vinyl acetate (EVA) had a melt index of 2.50 g/10 minutes, a density of 0.94 g/cc, and a vinyl acetate comonomer content of 18 weight percent. The EVA was obtained from DuPont. It is commercially available as Elvax™ 460. The ethylene/octene copolymer had a melt index of 4.0 g/10 minutes and a density of 0.9 g/cc. The ethylene/octane copolymer was obtained from The Dow Chemical Company. It is commercially available as Attane™ 4404.

The aluminum trihydroxide (ATH) had an average particle size of 1.1 microns. The calcium carbonate (CaCO3) was ground and coated with a fatty acid and had an average particle size of 3.5 microns. The magnesium hydroxide (Mg(OH)2) was precipitated and had an average particle size of 1.8 microns. The nanoclay was a synthetic organo-magadiite prepared as described in Patent Cooperation Treaty Application Serial No. WO 01/83370.

The zinc stearate was obtained as a standard polymer grade. The zinc oxide had a surface area of 9 m²/g and was obtained as Kadox™ 911P from Zinc Corporation of America. Irganox 1010 tetrakis [methylene(3,5-di-tert-butyl-4-hydroxyhydro-cinnamate)]methane is available from Ciba Specialty Chemicals Inc.

The polydimethylsiloxane had a viscosity at 25 degrees Celsius of 60,000 centistoke. The silicone concentrate contained 50 weight percent of ultra-high molecular weight silicone polymer in a low density polyethylene and was commercially available as MB50-002 from Dow Coming, Inc. The silica was Hi-Sil 135 from PPG Industries, Inc.

The compositions were extruded onto 18-gauge/19-strand wires and subjected to 10 MRad of 4.5 MeV electron beam to crosslink the insulating compositions.

### Nonconforming Examples 1-5, Comparative Example 6, and Example 7

TABLE I

| Components | N. Ex. 1 | N. Ex. 2 | N. Ex. 3 | N. Ex. 4 | N. Ex. 5 | C. Ex. 6 | Ex. 7 |
|---|---|---|---|---|---|---|---|
| EEA | 59.90 | 64.90 | 59.90 | 59.90 | 29.90 | | 29.90 |
| EVA | | | | | | 46.74 | |
| ATH | | | | 30.00 | | 50.00 | |
| CaCO3 | 30.00 | 30.00 | | | 60.00 | | 30.00 |
| Mg(OH)2 | | | 30.00 | | | | 30.00 |
| Nanoclay | | 5.00 | | | | | |
| Zinc stearate | | | | | | 0.35 | |
| Zinc oxide | | | | | | 2.21 | |
| Irganox 1010 | 0.10 | 0.10 | 0.10 | 0.10 | 0.10 | 0.70 | 0.10 |
| Silicone | 10.00 | | 10.00 | 10.00 | 10.00 | | 10.00 |
| concentrate | | | | | | | |

Wire Extrusion Parameters

| | | | | | | | |
|---|---|---|---|---|---|---|---|
| RPM | 50 | 50 | 50 | 55 | 55 | 50 | 55 |
| PSI | 2160 | 2000 | 2150 | 2000 | 2600 | 3250 | 3250 |

For the following data, the SAE J-1128 average burn time must be less than 70 seconds for the composition to pass. The MS-8288 average burn time must be less than 30 seconds for the composition to pass.

TABLE II

| Properties | N. Ex. 1 | N. Ex. 2 | N. Ex. 3 | N. Ex. 4 | N. Ex. 5 | C. Ex. 6 | Ex. 7 |
|---|---|---|---|---|---|---|---|
| Density | 1.16 | 1.19 | 1.14 | 1.14 | 1.53 | 1.38 | 1.49 |
| LOI | 40 | 22 | 28 | 24 | 33 | 26 | 39 |
| PHRR | 413.5 | 308.5 | 305 | 465 | 226.5 | 339.7 | 115.5 |
| TTPHRR | 102.5 | 97.5 | 142.5 | 135 | 132.5 | 155 | 185 |
| TTI | 59.5 | 54 | 73 | 46.5 | 78.5 | 63 | 111.5 |
| FIGRA | 4.0 | 3.2 | 2.1 | 3.4 | 1.7 | 2.2 | 0.6 |
| FPI | 0.14 | 0.18 | 0.24 | 0.10 | 0.35 | 0.19 | 0.97 |

SAE J-1128 Burn Test

| | | | | | | | |
|---|---|---|---|---|---|---|---|
| Burned to | yes | yes | no | yes | yes | no | no |
| clamp? | | | | | | | |
| Average | 180 | 132 | 30 | 200 | 140 | 35 | 42 |
| Burn Time | | | | | | | |
| (seconds) | | | | | | | |
| Pass | no | no | yes | no | no | yes | yes |

MS-8288 Burn Test

| | | | | | | | |
|---|---|---|---|---|---|---|---|
| Burned to | yes | no | no | no | no | no | no |
| clamp? | | | | | | | |
| Average | 80 | 74 | 27 | 63 | 58 | 5 | 18 |
| Burn Time | | | | | | | |
| (seconds) | | | | | | | |
| Pass | no | no | yes | no | no | yes | yes |

The cone calorimetry results were correlated to passing SAE J-1128 and MS-8288 formulations. Flame retardant compositions having a TTPHRR greater than or equal to about 140 seconds passed both the SAE J-1128 and MS-8288 tests.

Accordingly, flame retardant compositions, containing a metal carbonate, for the insulation layer of low tension primary automotive wire should be selected based upon having a time to peak heat release rate greater than or equal to about 140 seconds.

### Flame Retardant Compositions: Examples 8-12

TABLE III

| Components | Ex. 8 | Ex. 9 | Ex. 10 | Ex. 11 | Ex. 12 |
|---|---|---|---|---|---|
| EEA | 45.90 | 44.90 | 47.90 | | 49.90 |
| EVA | | | | | |
| Ethylene/Octene | | | | 49.90 | 50.00 |
| Copolymer | | | | | |
| CaCO3 | 25.00 | 25.00 | 25.00 | 50.00 | |
| Mg(OH)2 | 25.00 | 25.00 | 25.00 | | |
| Silica | | 5.00 | | | |
| Polydimethylsiloxane | | | 2.00 | | |
| Irganox 1010 | 0.10 | 0.10 | 0.10 | 0.10 | 0.10 |
| Silicone concentrate | 4.00 | | | | |

Properties

| | | | | | |
|---|---|---|---|---|---|
| Density | 1.36 | 1.40 | 1.36 | 1.35 | 1.40 |
| LOI | 29 | 26 | 29 | 21 | 25 |
| PHRR | 187 | 200 | 242 | 167 | 450 |
| TTPHRR | 160 | 145 | 145 | 150 | 148 |
| TTI | 127 | 81 | 114 | 80 | 67 |
| FIGRA | 1.2 | 1.4 | 1.7 | 1.1 | 3.0 |
| FPI | 0.68 | 0.41 | 0.47 | 0.48 | 0.15 |

The following formulations for Examples 8-12 represent compositions that will pass both the SAE J-1128 and MS-8288 tests.

### Surface Smoothness Examples

For the exemplified compositions (Comparative Example 13 and Examples 14-19), the insulating compositions were compounded using a laboratory-scale Brabender mixer. The compounds were then extruded onto a 20 AWG/7 strand wire in a 2.5-inch David-standard extruder at 1500 ft/min without curing the wires. The temperature profile of the extruder was set at 104/107/113/116/116° C. The melt temperature generally ranges from 133 degrees Celsius to 143 degrees Celsius. The wire construction was 20 AWG/7 strand TXL with 0.40 mm wall thickness according to SAE J-1128 specification. TXL was a thinwall crosslinked wire construction.

The following materials were used for the exemplified compositions. The ethylene-ethyl acrylate (EEA) had a melt index of 1.30 g/10 minutes, a density of 0.93 g/cc, and an ethyl acrylate comonomer content of 15 weight percent. The EEA was obtained from The Dow Chemical Company. It is commercially available as Amplify™ EA 100.

The silicone fluid had a viscosity at 25 degrees Celsius of 60,000 centistoke. The silicone fluid was commercially available as Dow Coming 200 Fluid 60,000 centistoke from Dow Corning, Inc. The silica was Hi-Sil 135 from PPG Industries, Inc.

A Mitutoyo surface roughness tester (Model SJ-400) with 10 microns stylus is used to measure the surface profile of the auto wire. The Ra roughness parameter is defined as the arithmetic mean of the absolute values of the measured surface profile from the mean line. 12 roughness measurements were taken on three small sections of extruded wire.

TABLE IV

| Component | C. Ex. 13 | Example 14 | Example 15 |
|---|---|---|---|
| EVA | 46.89 | 46.89 | 46.89 |
| Vinyl triethoxysilane | 0.60 | 0.60 | 0.60 |
| 3.2 micron CaCO3 | 9.50 | | |
| 2 micron CaCO3 | | 9.50 | |
| (surface treated) | | | |
| 1.1 micron CaCO3 | | | 9.50 |
| (surface treated) | | | |
| ATH | 38.00 | 38.00 | 38.00 |
| Silica | 2.50 | 2.50 | 2.50 |
| silicone fluid | 1.00 | 1.00 | 1.00 |
| Antioxidants | 1.51 | 1.51 | 1.51 |

Surface Roughness (microns)

| | | | |
|---|---|---|---|
| Ra | 2.4 | 2.1 | 1.8 |

The following table compares the surface roughness measurements for wire compositions containing or made from metal carbonates with different particle sizes.

TABLE V

| Component | Example 16 | Example 17 |
|---|---|---|
| EEA | 47.09 | 47.09 |
| Vinyl triethoxysilane | 0.40 | 0.40 |
| 2 micron CaCO3 | 9.50 | |
| 2 micron CaCO3 (stearic acid treated) | | 9.50 |
| ATH | 38.00 | 38.00 |
| Silica | 2.50 | 2.50 |
| silicone fluid | 1.00 | 1.00 |
| Antioxidants | 1.51 | 1.51 |

Surface Roughness (microns)

| | | |
|---|---|---|
| Ra | 1.5 | 1.5 |

The following table compares the surface roughness measurements for wire compositions containing or made from metal carbonates with and without surface treatments.

TABLE VI

| Component | Example 18 | Example 19 |
|---|---|---|
| EEA | 47.09 | 47.09 |
| Vinyl triethoxysilane | 0.40 | 0.40 |
| CaCO3 | 12.00 | 12.00 |
| ATH (1.0-1.2 microns) | 38.00 | |
| ATH (1.3-2.3 microns) | | 38.00 |
| silicone fluid | 1.00 | 1.00 |
| Antioxidants | 1.51 | 1.51 |

Surface Roughness (microns)

| | | |
|---|---|---|
| Ra | 1.5 | 1.8 |

The following table compares the surface roughness measurements for wire compositions containing or made from metal hydroxides with different particle sizes. The compositions were soaked with 1.15 weight percent Perkadox 14S.

What is claimed as new and desired to be protected by Letters Patent of the United States is:

1. An improved surface-smoothness, automotive wire comprising:
a. a metal conductor;
b. a flame retardant insulation layer, surrounding the metal conductor, prepared from a flame retardant composition comprising
(i) a crosslinkable thermoplastic ethylene/unsaturated ester copolymer having an ester content greater than or equal to about 10 weight percent,
(ii) a metal carbonate being present in amount sufficient to impart a time to peak heat release (TTPHRR), measured using cone calorimetry with a heat flux of 35 kW/m², of greater than or equal to about 140 seconds to a test specimen, having a length and width of 101.6 mm and a thickness of 1.3 mm, and
(iii) a crosslinking agent; and
c. a wire jacket surrounding the insulation layer.

2. The automotive wire of claim 1 wherein the flame retardant composition further comprises a metal hydrate in an amount such that the combination of the metal carbonate and the metal hydrate impart the TTPHRR of greater than or equal to about 140 seconds to the test specimen.

3. The automotive wire of claim 3 wherein the metal hydrate having a particle size less than about 3 microns.

4. An improved surface-smoothness, automotive wire comprising:
a. a metal conductor;
b. a flame retardant insulation layer, surrounding the metal conductor, prepared from a flame retardant composition comprising
(i) a crosslinkable thermoplastic polymer,
(ii) a metal carbonate
(1) having a particle size less than about 3 microns and
(2) being present in amount sufficient to impart a time to peak heat release (TTPHRR), measured using cone calorimetry with a heat flux of 35 kW/m², of greater than or equal to about 140 seconds to a test specimen, having a length and width of 101.6 mm and a thickness of 1.3 mm, and
(iii) a crosslinking agent; and
d. a wire jacket surrounding the insulation layer.

5. The automotive wire of claim 4 wherein the flame retardant composition further comprises a metal hydrate in an amount such that the combination of the metal carbonate and the metal hydrate impart the TTPHRR of greater than or equal to about 140 seconds to the test specimen.

6. The automotive wire of claim 5 wherein the metal hydrate having a particle size less than about 3 microns.
